(19) United States
(12) Patent Application Publication
(10) Pub. No.: US 2015/0134163 A1
(43) Pub. Date: May 14, 2015

(54) ELECTRIC DRIVE CONTROL SYSTEM

(71) Applicant: Caterpillar Inc., Peoria, IL (US)

(72) Inventors: Zachary R. Carter, Decatur, IL (US); Srikar Thaduvayi, Peoria, IL (US); Karl Schneider, Decatur, IL (US); Michael A. McKeever, Canton, IL (US); Joseph E. Roth, West Lafayette, IN (US)

(73) Assignee: Caterpillar Inc., Peoria, IL (US)

(21) Appl. No.: 14/078,672

(22) Filed: Nov. 13, 2013

(51) Int. Cl. B60W 20/00; B60K 11/06; H02P 9/00

(52) U.S. Cl. CPC B60W 20/108; H02P 9/008; B60K 11/06; B60W 2050/0026
USPC 701/22

(57) ABSTRACT

An electric drive control system for a machine is provided. The electric drive control system includes a sensor and a drivetrain control module operatively coupled to the sensor. The sensor is configured to determine one or more operational parameters associated with the machine. The drivetrain control module is further operatively coupled to a power source controller associated with a power source and a generator controller associated with a generator. The drivetrain control module is configured to determine a desired operating mode of the machine and selectively regulate one or parameters associated with the power source based on a predefined dataset corresponding to the desired operating mode of the machine. The drivetrain control module is further configured to selectively adjust an amount of power produced by the generator based on the predefined dataset corresponding to the desired operating mode of the machine.

### TECHNICAL FIELD

The present disclosure relates to an electric drive machine, and more specifically to an electric drive control system for the electric drive machine.

### BACKGROUND

Electric drive systems are commonly used in various heavy machines which are commonly used in mining, heavy constructions, and various other applications. Irrespective of the application, one thing that is commonly desired in all the machines is fuel efficiency. Fuel efficiency has been an ever evolving field of research. Conventionally, various methods and strategies have been devised to increase the fuel efficiency of a machine. Still there remains a lot of scope in further increasing the fuel efficiency of these electric drive machines.

United States Published Application No. 2012/0245784 relates to a method for the control-side handling of drive torque and/or braking torque in a motor vehicle having as a drive assembly which comprises a hybrid drive with an internal combustion engine and at least one electric machine. An engine control device is assigned to the internal combustion engine and a hybrid control device is assigned to the, or each, electric machine. The engine control device and the hybrid control device send and receive drive-torque-relevant and/or braking-torque-relevant data via a data bus, and further control devices likewise send and receive drive-torque-relevant and/or braking torque-relevant data via the data bus. The drive torque and/or braking torque is centrally managed by the hybrid control device.

### SUMMARY OF THE DISCLOSURE

In one aspect of the present disclosure, an electric drive control system for a machine is provided. The electric drive control system includes a sensor and a drivetrain control module operatively coupled to the sensor. The sensor is configured to determine one or more operational parameters associated with the machine. The drivetrain control module is further operatively coupled to a power source controller associated with a power source, and a generator controller associated with a generator. The drivetrain control module is configured to determine a desired operating mode of the machine and selectively regulate one or more parameters associated with the power source based on a predefined dataset corresponding to the desired operating mode of the machine. The drivetrain control module is further configured to selectively adjust an amount of power produced by the generator based on the predefined dataset corresponding to the desired operating mode of the machine.

In another aspect, a method for operating a machine using an electric drive control system is provided. The method includes determining a desired operating mode associated with the electric drive machine. The method further includes selectively adjusting one or more engine parameters based on a predefined dataset corresponding to the determined desired operating mode of the electric drive machine. Furthermore, the method includes selectively adjusting an amount of power produced by a generator of the machine based on the predefined dataset corresponding to the determined desired operating mode of the electric drive machine.

Other features and aspects of this disclosure will be apparent from the following description and the accompanying drawings.

### BRIEF DESCRIPTION OF THE DRAWINGS

FIG. 1 is an exemplary machine;

FIG. 2 is a block diagram of an electric drive control system for the machine of FIG. 1, according to an embodiment of the present disclosure; and

FIG. 3 is a flowchart of a method of operating the machine using the electric drive control system of FIGS. 1 and 2.

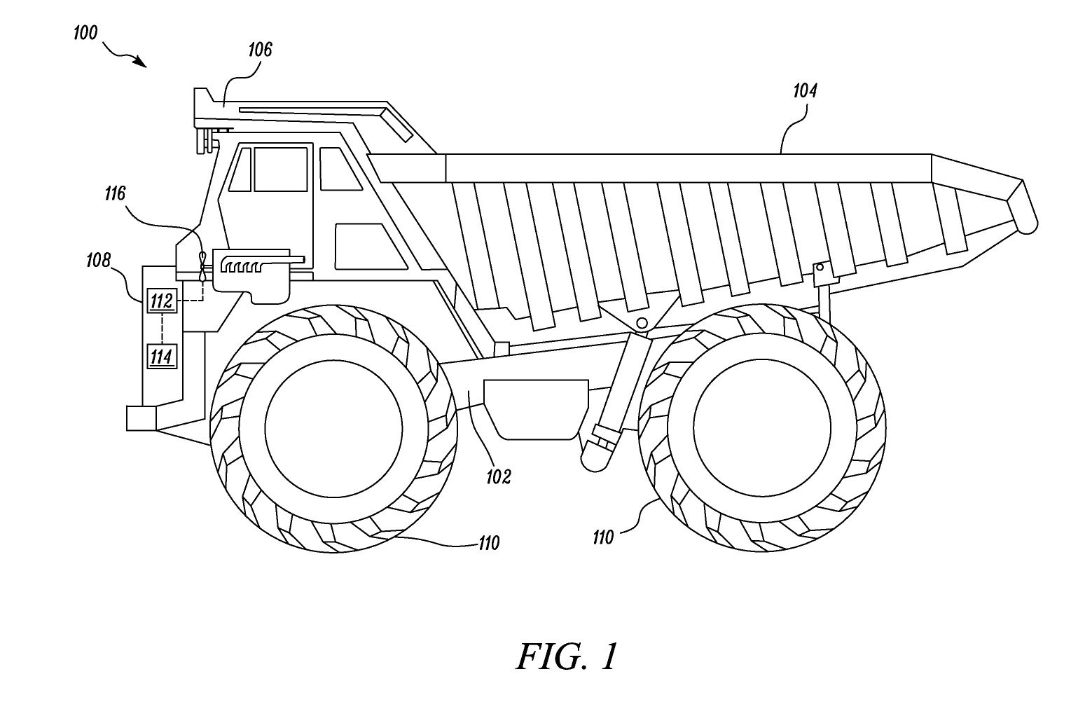

### DETAILED DESCRIPTION

Wherever possible, the same reference numbers are used throughout the drawings and the present disclosure to refer to the same or the like parts. The present disclosure, relates to an electric drive control system for an electric drive machine. FIG. 1 illustrates an exemplary electric drive machine 100, hereinafter referred to as the machine 100, according to an aspect of the present disclosure. More specifically, the machine 100 is embodied as a large mining truck. It should be noted that the machine 100 may include any other industrial machine including, but not limited to, a large mining truck, an articulated truck, an off-highway truck and the like. In various another embodiments, the machine 100 may be one of various types of machinery used in a number of industries such as mining, agriculture, construction, forestry, waste management, and material handling among others, such as trains, locomotives etc.

Referring to FIG. 1, the machine 100 may include a frame 102. A payload carrier 104 may be pivotally mounted to the frame 102. Further, an operator cab 106 may be mounted on the frame 102, such as above an engine enclosure 108 and on a front part of the frame 102. The machine 100 may be supported on the ground by a plurality of ground engaging members 110, such as wheels. One or more power sources 112 may be housed within the engine enclosure 108. The power source 112 may be a diesel engine, a gasoline engine, a gaseous fuel-powered engine, a hydrogen-powered engine, or any other type of combustion engine known in the art. Alternatively, the power source 112 may be a non-combustion source of power such as a fuel cell, a power storage device, a solar cell, or another suitable source of power.

The machine 100 may include a generator 114 coupled to the power source 112 and configured to generate electricity for the machine 100. The electricity produced by the generator 114 may be used for operating the machine 100 and/or may be stored for future usage into one or more power storage devices (not shown) within the machine 100. The machine 100 may further include a cooling fan 116 for cooling the power source 112 of the machine 100.

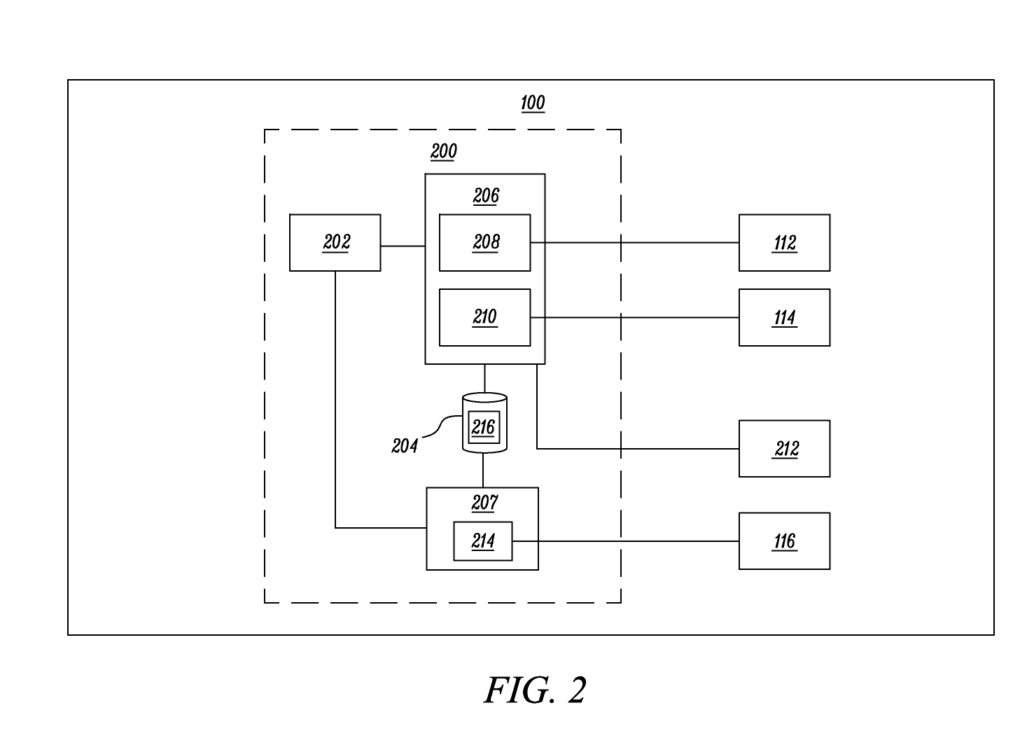

In an aspect of the present disclosure, an electric drive control system 200 is provided in the machine 100, as illustrated in FIG. 2. As shown in FIG. 2, the electric drive control system 200 may include one or more sensors 202, a database 204, a drivetrain control module 206 and a fan control module 207.

The sensors 202 are associated with the machine 100 and configured to detect one or more operational parameters associated with the power source 112 and the machine 100. In an exemplary embodiment, the sensors 202 may include speed sensors and/or temperature sensors associated with the ground engaging members 110 and the power source 112 of the machine 100 respectively. In various other embodiments, the sensors 202 may include voltage and current sensors. The operational parameters associated with the machine 100 and the power source 112 may include the speed of the machine 100 provided by the speed sensors on the ground engaging members 110 and the temperature of the power source 112 provided by the temperature sensors on the power source 112 respectively. Based on the detected operational parameters associated with the machine 100 and the power source 112, the sensors 202 may be configured to send a corresponding input signal to the drivetrain control module 206 and the fan control module 207 of the electric drive control system 200.

The one or more operational parameters may be indicative of various operating modes of the machine 100. The various operating modes of the machine 100 may include a full load operating mode, a partial load operating mode and a retarding mode. The full load operating mode of the machine 100 may be understood as a mode of operation of the machine 100, for which the machine 100 needs full power supply from the power source 112. Examples of the full load operating mode conditions of the machine 100 may be during high speed movement of the machine 100, or when the machine climbs up a hill etc. On the contrary, the partial load operating mode of the machine 100 may be understood as a mode of operation of the machine 100, for which the machine 100 does not need full power from the power source 112 to operate. Examples of the partial load operating conditions may include low speed movement of the machine 100, flat haul operations, downstream movement of the machine 100 etc. Furthermore, the retarding mode may be the mode during retarding or braking events in the machine 100. In an aspect of the present disclosure, the retarding mode may also be a partial load operation mode of the machine 100.

In an aspect of the present disclosure, the drivetrain control module 206 may include a power source controller 208 and a generator controller 210. The drivetrain control module 206 may be operatively coupled to an engine control module (ECM) 212 of the machine 100. The drivetrain control module 206 may be configured to receive an input from the machine ECM 212 indicative of a current operating mode of the machine 100. For example, the current operating mode of the machine 100 may be set to a low power mode, such as for flat haul operations, or speed limited applications situations and/or the full load operating mode, during which, the machine components are supplied with full power to operate. In an exemplary embodiment, by default, the machine 100 may be set to operate at the full load operating mode.

Furthermore, based on the operational parameters received from the sensors 202 and the current operating mode of the machine 100 received from the machine ECM 212, the drivetrain control module 206 may be configured to switch the machine operating mode to a desired operating mode as and when required by the machine 100 during its run. The desired operating mode of the machine 100 may be the partial load operating mode and/or the retarding mode. In an exemplary embodiment of the present disclosure, the drivetrain control module 206 may be configured to reduce one or more parasitic loads of the machine 100 such as reduce the power generation and power usage if desired, i.e., during the partial load operating mode and the retarding mode by selectively regulating the power source controller 208, and the generator controller 210. For example, the fan control module 207 may adjust the speed of the fan 116 to yield maximum fuel efficiency. In various other embodiments of the present disclosure, other parasitic loads of the machine 100, such as speed of a variable brake cooling pump, position of a brake cooling diverter valve position etc.

In an aspect of the present disclosure, based on the speed of the machine 100, the drivetrain control module 206 may be configured to detect whether the machine 100 is required to operate at the full load operating mode, or partial load operating mode or the retarding mode. Similarly, based on the temperature and a required cooling of the power source 112, fan control module 207 may adjust the speed of the fan 116 thus adjusting the air flow.

In an exemplary embodiment, the database 204 is configured to store a number of predefined datasets 216 corresponding to the full load operating mode, the partial load operating mode and the retarding mode. Further, the database 204 may also store the various operational parameters of the power source 112 and the machine 100, as detected by the sensors 202. In an aspect of the present disclosure, the sensors 202 may also be operatively coupled with the database 204 to continuously update operational parameters of the machine 100.

Further, the predefined dataset 216 may include a number of predefined conditions based on which the drivetrain control module 206 may determine the desired operating mode of the machine 100. In an aspect of the present disclosure, the drivetrain control module 206 may compare the detected operational parameters of the power source 112 and the machine 100 and the current operating mode of the machine 100 with the various conditions stored in the predefined datasets 216 to determine the desired operating mode of the machine 100. For example, a condition may be specified as if the speed of the machine 100 is greater than or equal to 30 kilometers per hour, and the machine 100 is demanding less than full power from the power source and the current operating mode of the machine 100 is full load operating mode, then the desired operating mode of the machine 100 is the partial load operating mode. Another condition may specify that if the speed of the machine 100 is less than 30 kilometers per hour, the machine 100 is not performing any function and the current operating mode of the machine 100 is full load operating mode, then the desired operating mode of the machine 100 is the partial load operating mode. Similarly, another condition may specify that if the machine 100 speed is equal to zero, and the machine 100 is performing stationary function, then the machine 100 is operating at the full load operating mode. Still another condition may specify that if the brakes of the machine 100 are applied and the current operating mode of the machine 100 is full load operating mode, then the desired operating mode of the machine 100 is the retarding mode. Similarly, the database 204 may store various conditions, based on which the drivetrain control module 206 may detect the desired operating mode of the machine 100. Therefore, accordingly the drivetrain control module 206 may be configured to switch to the desired operating mode of the machine 100, which may be the partial load operating mode and/or the retarding mode.

In an exemplary embodiment of the present disclosure, the predefined dataset 216 may also include a number of engine maps indicative of various engine settings and look up table corresponding to the various operating modes of the machine 100. The engine map and the lookup table may be indicative of a number of load management parameters corresponding to the various operating modes of the machine 100. Although, the illustrated embodiment shows the database 204 and the predefined dataset 216 to store all the operational parameters associated with the machine 100, the predefined conditions, the engine settings and the lookup tables, it will be understood by a person having ordinary skill in the art that the drive train controller 206, and the machine ECM 212 may have their respective databases to store the predefined conditions associated with the various operating mode of the machine 100, and a predefined dataset for the various operational parameters associated with the machine 100 received from the sensors 202, respectively.

Furthermore, in an aspect of the present disclosure, the drivetrain control module 206 may be configured to communicate with the database 204 to selectively implement a corresponding engine settings and/or a look up table based on the desired operating mode of the machine 100. In an exemplary embodiment, the drivetrain control module 206 may select and implement engine setting corresponding to the partial load operating mode of the machine 100 when the machine 100 is required to be in the partial load operating mode.

In an aspect of the present disclosure, the drivetrain control module 206 may be configured to selectively regulate one or more parameters of the power source 112 based on the predefined dataset 216 corresponding to the desired operating mode of the machine 100 by using the power source controller 208. For example, the drivetrain control module 206 may be configured to selectively limit and/or lower a rotational speed of the power source 112 based on the desired operating mode of the machine 100. In an embodiment of the present disclosure, the drivetrain control module 206 may be configured to selectively limit the rotational speed of the power source 112 to about 1800 rotations per minute (rpm) during the partial load operating mode of the machine 100. In another exemplary embodiment of the present disclosure, the drivetrain control module 206 may be configured to lower the rotational speed of the power source 112 to about 1050 rpm, during the retarding mode of the machine 100.

In an aspect of the present disclosure, the drivetrain control module 206 may further be configured to selectively adjust an amount of power produced by the generator 114 based on the predefined dataset 216 corresponding to the desired operating mode of the machine 100 by using the generator controller 210. For example, the drivetrain control module 206 may reduce and/or limit the amount of power produced by the generator 114, by controlling the generator controller 210 when the machine 100 is operating at the partial load operating mode. In an exemplary embodiment, the amount of power to be generated by the generator 114 may be predefined within the predefined dataset 216 corresponding to the desired operating mode of the machine 100.

In an exemplary embodiment of the present disclosure, the fan control module 207 may include a fan controller 214 associated with the fan 116 for cooling the power source 112. The fan control module 207 may be configured to receive the temperature of the power source 112 from the sensors 202 and selectively adjust a rotational speed of the cooling fan 116 based on the temperature of the power source 112, the required cooling of the power source 112 and predefined dataset 216 corresponding to the desired operating mode of the machine 100 by using the fan controller 214. For example, when the machine 100 is retarding or operating in the retarding mode, the power source 112 may not require sufficient cooling, therefore, the rotational speed of the cooling fan 116 may be reduced by controlling the fan controller 214. In another example, when the machine 100 is operating at the partial load operating mode, then the temperature of the power source 112 may be detected by using one or more sensors associated with the power source 112. If the temperature of the power source 112 is already low during the partial load operating mode, then the fan control module 207 may regulate and reduce the rotational speed of the cooling fan 116.

Although, the electric drive control system 200 is shown to be a separate component of the machine 100, it will be appreciated by a person having ordinary skill in the art, that the electric drive control system 200 may form an integral part of the machine engine control module (ECM) 212.

### INDUSTRIAL APPLICABILITY

The industrial applicability of the electric drive control system 200 for the electric drive machine 100, described herein will be readily appreciated from the foregoing discussion. Fuel efficiency of any type of machine, has been an ever evolving field of research. Conventionally, various methods and strategies have been devised to increase the fuel efficiency of a machine. Still there remains a lot of scope in further increasing the fuel efficiency of these electric drive machines.

The present disclosure discloses the electric drive control system 200 to increase the fuel efficiency of the machine 100. The electric drive control system 200 determines when the machine 100 is required to operate at the partial load operating mode. When the machine 100 is determined to operate at the partial load operating mode, the drivetrain control module 206 reduces and/or limits the one or more parasitic loads such as the power generated and the power consumed to prevent power wastage and therefore increase the fuel efficiency of the machine 100.

In an aspect of the present disclosure, the electric drive control system 200 switches the current operating mode to the desired operating mode of the machine 100 as and when required during the run. For example, the electric drive control system 200 implements the engine settings corresponding to the desired operating mode of the machine 100, such as the partial load operating mode and/or the retarding mode. Further, the electric drive control system 200 reduces and/or limits the rotational speed of the power source 112, limits the output electric power produced by the generator 114. Further, the fan control module 207 reduces the rotational speed of the cooling fan 116 when desired, i.e., during the partial load operating mode and/or the retarding mode. This regulates the power produced as well as the power consumed during the partial load operating mode, when the machine 100 doesn't require them. Therefore, there is no wastage of the power and the fuel, thereby increasing the fuel efficiency of the machine 100. Additionally, the electric drive control system 200 reduces the load on the power source 112.

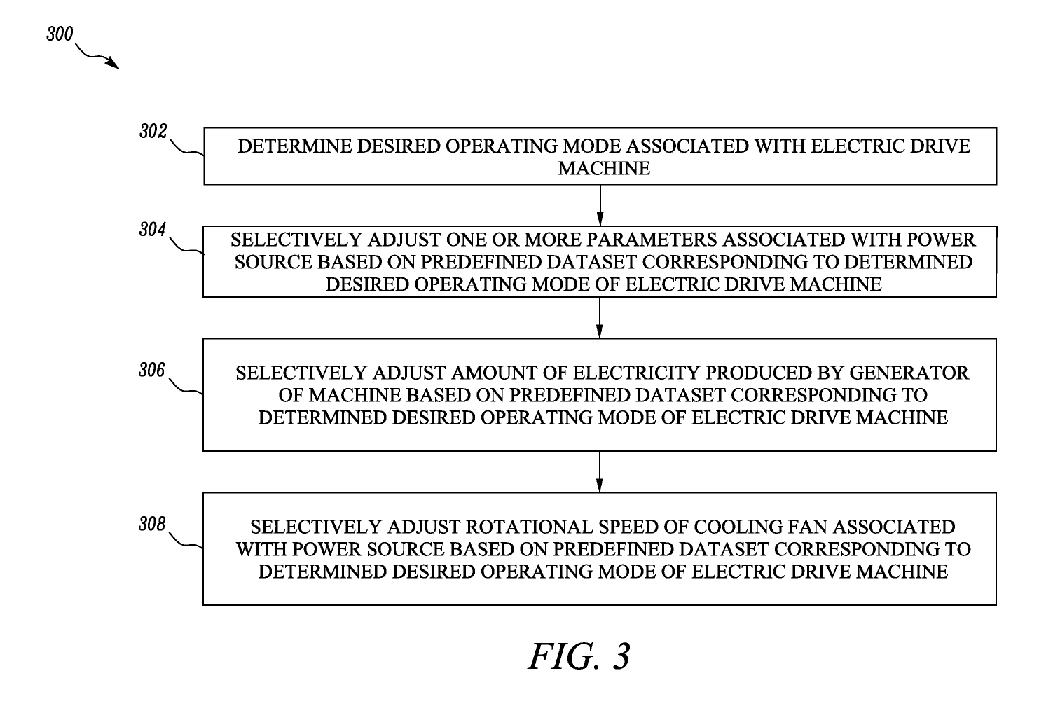

FIG. 3 illustrates a flowchart for a method of operating the machine 100 using the electric drive control system 200. Initially, at step 302, the desired operating mode of the machine 100 is determined. In an aspect of the present disclosure, the desired operating mode of the machine 100 may be one of the full load operating mode, partial load operating mode, and the retarding mode. In an exemplary embodiment, one or more operational parameters associated with the machine 100 and the power source 112 are detected. The sensors 202 of the electric drive control system 200 may determine the one or more operational parameters associated with the machine 100 and the power source 112. Examples of the sensors 202 may include temperature sensors associated with the power source, and/or the speed sensors associated with the ground engaging members 110 of the machine 100. In various other embodiments, the sensors 202 may include voltage and current sensors.

Further, the current operating mode of the machine 100 is determined. In an embodiment of the present disclosure, the drivetrain control module 206 determines the current operating mode of the machine 100. Based on a comparison of the one or more operational parameters associated with the machine 100 and the power source 112 respectively, and the current operating mode of the machine 100 with the predefined dataset 216 defining various conditions corresponding to the various operating modes of the machine 100, the drivetrain control module 206 may determine the desired operating mode of the machine 100.

Further, at step 304, one or more parameters associated with the power source 112 may be selectively adjusted based on the predefined dataset 216 corresponding to the determined desired operating mode of the machine 100. In an exemplary embodiment of the present disclosure, the drivetrain control module 206 may selectively adjust the one or more parameters associated with the power source 112 by using the power source controller 208. The drivetrain control module 206 may be configured to select the corresponding engine settings and/or the lookup table from the predefined dataset 216 corresponding to the determined desired operating mode of the machine 100. Therefore, when the desired operating mode of the machine 100 is determined to be the partial load operating mode, then the drivetrain control module 206 may implement the engine settings corresponding to the partial load operating mode.

Further, the rotational speed of the power source 112 may be regulated based on the determined desired operating mode of the machine 100 by using the power source controller 208. In an embodiment of the present disclosure, the rotational speed of the power source 112 may be limited to about 1800 rpm during the partial load operating mode of the machine 100. In another exemplary embodiment of the present disclosure, the rotational speed of the power source 112 may be lowered to about 1050 rpm during the retarding mode of the machine 100.

Further, at step 306, the amount of power produced by the generator 114 of the machine 100 is selectively adjusted based on the determined desired operating mode of the machine 100. For example, the drivetrain control module 206 may adjust the amount of power produced by the generator 114 by controlling the generator controller 210 associated with the generator 114.

Furthermore, at step 308, the rotational speed of the cooling fan 116 is selectively adjusted based on the determined desired operating mode of the machine 100. For example, based on the temperature of the power source 112 during the partial load operating mode, the fan control module 207 may lower the rotational speed of the cooling fan 116 by controlling the fan controller 214 associated with the cooling fan 116.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An electric drive control system for a machine comprising:
a sensor configured to determine one or more operational parameters associated with the machine; and
a drivetrain control module operatively coupled to the sensor, a power source controller associated with a power source and a generator controller associated with a generator of the machine, the drivetrain control module configured to:
determine a desired operating mode of the machine based at least in part on the one or more operational parameters;
selectively regulate one or more parameters associated with the power source based on a predefined dataset corresponding to the desired operating mode of the machine; and
selectively adjust an amount of power produced by the generator based on the pre-defined dataset corresponding to the desired operating mode of the machine.

2. The electric drive control system of claim 1, wherein the desired operating mode is at least one of a full load operating mode, a partial load operating mode and a retarding mode.

3. The electric drive control system of claim 2, wherein the drivetrain control module is configured to selectively limit a rotational speed of the power source during the partial load operating mode of the machine.

4. The electric drive control system of claim 2, wherein the drivetrain control module is configured to selectively lower a rotational speed of the power source during the retarding mode of the machine.

5. The electric drive control system of claim 1 further includes a fan control module operatively coupled to a fan controller for a cooling fan associated with the power source.

6. The electric drive control system of claim 5, wherein the fan control module is further configured to selectively control the fan controller to adjust a rotational speed of the cooling fan based on the predefined dataset corresponding to the operating mode of the machine.

7. The electric drive control system of claim 1, wherein the pre-defined dataset includes one or more of an engine map and a look-up table corresponding to the desired operating mode of the machine.

8. A method comprising:
determining a desired operating mode associated with an electric drive machine;
selectively adjusting one or more parameters associated with a power source based on a predefined dataset corresponding to the determined desired operating mode of the electric drive machine; and
selectively adjusting an amount of power produced by a generator of the machine based on the predefined dataset corresponding to the determined desired operating mode of the electric drive machine.

9. The method of claim 8, wherein determining the desired operating mode associated with the electric drive machine further comprises detecting one or more operational parameters associated with the electric drive machine.

10. The method of claim 8 further comprising selectively adjusting a rotational speed of a cooling fan associated with the power source based on the predefined dataset corresponding to the determined operating mode of the machine.

11. The method of claim 8, wherein the desired operating mode is at least one of a full load operating mode, a partial load operating mode and a retarding mode.

12. The method of claim 11, wherein selectively adjusting the one or more engine parameters further comprising limiting a rotational speed of the power source during the partial load operating mode of the electric drive machine.

13. The method of claim 11, wherein selectively adjusting the one or more engine parameters further comprising lowering a rotational speed of the power source during the retarding operating mode of the electric drive machine.

14. An electric drive machine comprising:
a power source;
a generator coupled to the power source and configured to generate power; and
an electric drive control system operatively coupled to a power source controller associated with the power source and a generator controller associated with the generator, the electric drive control system including:
a sensor configured to determine one or more operational parameters associated with the machine; and
a drivetrain control module operatively coupled to the sensor and configured to:
determine a desired operating mode of the machine based at least in part on the one or more operational parameters;
selectively regulate one or more parameters associated with the power source based on a predefined dataset corresponding to the desired operating mode of the machine; and
selectively adjust an amount of power produced by the generator based on the predefined dataset corresponding to the desired operating mode of the machine.

15. The electric drive machine of claim 14, wherein the desired operating mode is at least one of a full load operating mode, a partial load operating mode and a retarding mode.

16. The electric drive machine of claim 15, wherein the drivetrain control module is configured to limit a rotational speed of the power source during the partial load operating mode of the electric drive machine.

17. The electric drive machine of claim 15, wherein the drivetrain control module is configured to lower a rotational speed of the power source during the retarding operating mode of the electric drive machine.

18. The electric drive machine of claim 14, wherein the electric drive control system further includes a fan control module operatively coupled to a fan controller for a cooling fan associated with the engine of the electric drive machine.

19. The electric drive machine of claim 18, wherein the fan control module is further configured to selectively control the fan controller to adjust a rotational speed of the cooling fan based on the pre-defined dataset corresponding to the operating mode of the electric drive machine

20. The machine of claim 14, wherein the pre-defined dataset includes one or more of an engine map and a look-up table corresponding to the desired operating mode of the machine.
